(19) United States
(12) Patent Application Publication
(10) Pub. No.: US 2007/0223518 A1
(43) Pub. Date: Sep. 27, 2007

(54) Interface and method for coupling different types of data between a pair of devices

(76) Inventor: Patanit Sanpitak, Highland Park, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/385,616

(22) Filed: Mar. 21, 2006

(51) Int. Cl. H04L 12/66; H04J 3/22

(52) U.S. Cl. 370/463; 370/465

(57) ABSTRACT

A Single Photon Emission Computerize Tomography (SPECT) camera having an interface for coupling command data and image data between a master camera and a slave camera. The interface includes a category 5 cable having two pairs of twisted pairs connected between the master camera and the slave camera. The master camera and the slave camera have a pair of differential signal interfaces, each one of such differential signal interfaces being connected to a different end of a first one of the pair of the twisted pairs for carrying the image data; and a pair of Ethernet physical layers each one being connected to a different end of a second one of the pair of twisted pairs for carrying the command data.

### TECHNICAL FIELD

This invention relates generally to interfaces and more particularly to interfaces and methods for coupling different types of data between a pair of devices, one type of data requiring a higher data rate than the other type of data.

### BACKGROUND AND SUMMARY

As is known in the art, it is sometimes necessary to couple different types of data between a pair of devices, one type of data requiring a higher data rate than the other type of data. For example, radionuclide imaging devices, such as gamma cameras, are used in the medical field to measure radioactive emissions emanating from a subject's body and to form a comprehensible output from these measurements, typically in the form of an image that graphically illustrates the distribution of the emissions within the patient's body. The emissions originate from a decaying radioactive tracer that has been intentionally introduced into the subject's body, and therefore, the image produced by the radionuclide imaging device represents the distribution of the tracer within the subject's body. The radioactive tracer is a pharmaceutical compound to which an electromagnetic radiation emitting nuclide has been attached and which undergoes a physiological process after introduction into the body and exhibits an affinity for a certain organ or tissue.

The radionuclide imaging device has one or more gamma detectors that detect the number of emissions, generally gamma rays in the range of 140 keV. Each of the detected emissions is a “count,” and the detector determines the number of counts at different spatial positions. The imager then uses the count tallies to form an estimate of the distribution of the tracer, typically in the form of a graphical image having different colors or shadings that represent the count tallies.

It is further known in the field of radionuclide imaging that the performance of the imager can be improved through the use of multiple radiation or gamma detectors. The use of multiple detectors (one sometimes being referred to as a master detector and the other a slave detector) is advantageous because the radionuclide imager may collect samples from a target in less time. An imager having two detectors, for instance, may scan a target twice as fast as an imager having a single detector. Furthermore, the use of multiple detectors to scan a target may improve the resolution of the scanning by reducing the variance and resulting statistical error produced by a single detector.

More particularly, a SPECT (Single Photon Emission Computerize Tomography) Camera (a.k.a. Gamma Camera) uses one or more detectors to detect gamma ray events emitted from an injected patient to create SPECT images. A Gamma Detector typically includes scintillating material such as Thallium Iodide doped Sodium Iodide (NaI(TI)) for interacting with gamma rays, creating photons, which are converted into electrical signals by arrays of Photo Multiplier Tubes (PMT). The electrical signals are electronically processed to create Gamma event image data that can be further processed to create the SPECT image by the acquisition computer. Each Gamma Detector includes electronics that require communication interfaces with an acquisition computer. Typically the communication interfaces are generally separated into 2 independent channels, i.e., a command data channel and an image data channel) due to their differences in the amount of data, speed and time lag requirements. For example, the function of the command interface is for the acquisition computer to control and set the gamma detector function/operation whereas the function of the image data interface is to transfer image data from the detector to the acquisition computer. Thus, the data command interface carries a relatively low or medium amount of data and has a relatively slow or medium data rate requirement compared to the relatively high data rate required for the image data interface which caries a relatively large amount of data and where time delay in transmission of such image data is critical.

Typically, existing Gamma detector products use separate hardware for the command and image data interfaces channels. The command interface channel typically uses the RS-485 interface physical layer with a customized communication protocol. The image data interface channel typically uses the ‘TAXI’ interface chipset which is one of the few available high speed data interface physical layer at the time. The ‘TAXI’ interface is designed to be a one-way image data transfer from the detector to the acquisition computer, therefore, there is a requirement to have another RS-485 interface channel from the acquisition computer to the detector to be used as the ‘Clear-To-Send’ (CTS) signal for data flow control. Due to the difference in the physical layer properties (RS485 and TAXI), separate cabling is required.

As is also known in the art, CAT5 (short for category 5) network cabling is based on the EIA/FIA 568 Commercial Building Telecommunications Wiring Standard developed by the Electronics Industries Association as requested by the Computer Communications Industry Association in 1985. CAT5 network cabling consists of four twisted pairs of copper wire terminated by RJ45 connectors. CAT5 cabling supports frequencies up to 100 MHz and data rates up to 1000 Mbps. It has been be used for ATM, token ring, 1000Base-T, 100Base-T, and 10Base-T networking.

A need exists for simplifying complex cabling in the existing interface by combining command and image data interface into one common media.

A further need exists for resolving issues of obsolescence with non-industrial standard components by utilizing industrial standard components. Component obsolescence is a major problem in medical equipment industries due to their longer product life cycle compared with commercial products.

A need also exists for utilizing both pairs of wires. In the standard Ethernet 100BaseTx communication interface, only 2 twisted pair conductors of the standard CAT5 cable are used. This leave 2 unused twisted pair conductors for a full duplex Low Voltage Differential Signal (LVDS) communication interface. The Ethernet 100BaseTx also require having an isolation component at each node; therefore, in order for the LVDS to use the same hardware connector with the Ethernet, the LVDS also has to be able to interface via the same isolation component that the Ethernet used. Thus, a 10/100/100BaseT standard connector is used as an isolation connector in order to utilize all 4 twisted pair conductors of the CAT5 cable.

### SUMMARY

The present invention in its several disclosed embodiments overcomes the problems encountered with the prior art with respect to providing an interface that selectively utilizes two signals.

In accordance with an embodiment of the invention, a method is provided for coupling low voltage differential signals and Ethernet physical layer signals through a common transmission medium.

In one embodiment, the common transmission medium is a cable.

In another embodiment, the cable is a category 5 cable.

In accordance with an aspect of the invention, an interface is provided for coupling different types of data between a pair of devices. The interface includes a category 5 cable having two pairs of twisted pairs connected to the pair of devices. The pair of devices include: a pair of differential signal interfaces, each one of such differential signal interfaces being connected to a different end of a first one of the pairs of twisted pairs; and a pair of Ethernet physical layers each one being connected to a different end of a second one of the pair of twisted pairs.

In accordance with another aspect of the present invention, a Single Photon Emission Computerize Tomography (SPECT) camera is provided having an interface for coupling command data and image data between a master camera and a slave camera. The interface includes a category 5 cable having a pair of twisted pairs connected between the master camera and the slave camera. The master camera and the slave camera have a pair of differential signal interfaces, each one of such differential signal interfaces being connected to a different end of a first one of the pair of twisted pairs for carrying the command data; and a pair of Ethernet physical layers each one being connected to a different end of a second one of the pair of twisted pairs for carrying the image data.

In accordance with a further aspect of the present invention, a method is provided for coupling different types of data between a pair of devices, one type of data requiring a higher data rate than the other type of data. The method includes passing the higher rate data through a first pair of a pair of twisted pairs of a category 5 cable and passing the other type of data through a second pair of pair of twisted pairs the category 5 cable.

In one embodiment, the method includes terminating the first pair of the pair of twisted pairs in differential signal interfaces and terminating the second pair of the pair of twisted pairs in Ethernet physical layers.

In one embodiment, one of the pair of devices is a master camera of a SPECT and the other device is a slave camera in the SPECT and wherein the higher data rate type data is image data and the other type of data is command data.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a Single Photon Emission Computerize Tomography Camera having a hybrid coherent communication interface between a Master detector and a Slave detector according to an exemplary embodiment of the present invention; and

FIG. 2 is a block diagram of the hybrid coherent communication interface of FIG. 1 according to an exemplary embodiment of the present invention.

Like reference symbols in the various drawings indicate like elements.

### DETAILED DESCRIPTION OF EXEMPLARY EMBODIMENTS

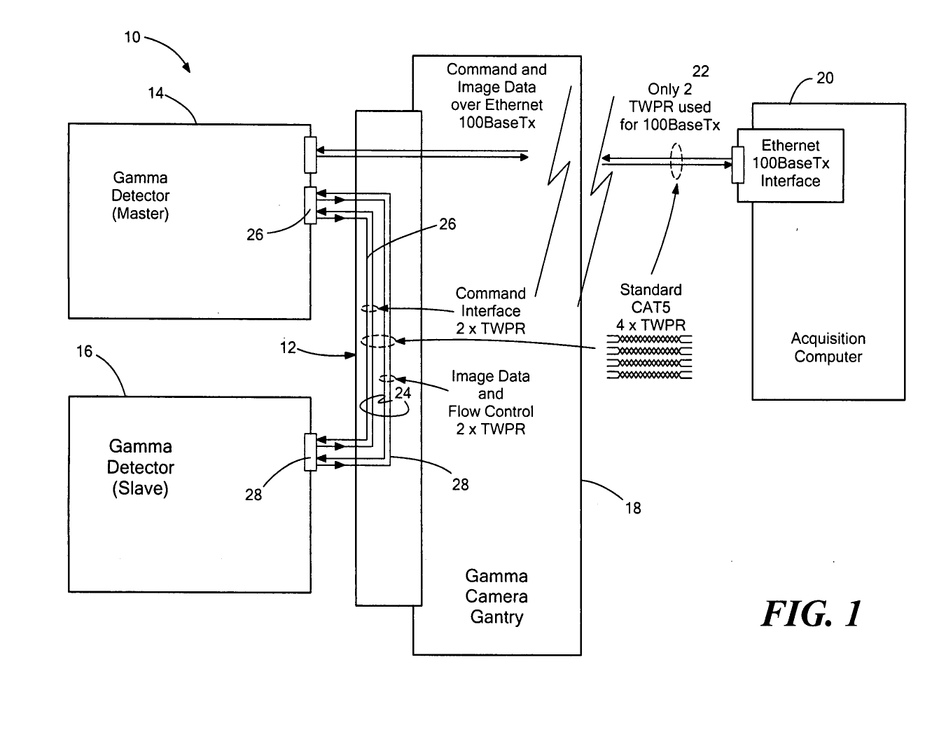

Referring now to FIG. 1, a SPECT camera 10 is shown to include a hybrid coherent communication interface (Detector Link Interface) 12 between a Master detector 14 and a Slave detector 16. The Master detector 14 and Slave detector 16 are connected to a gamma camera gantry 18 with command and image data passing between the detectors and an acquisition computer 20 through a cat-5 cable 22, as shown.

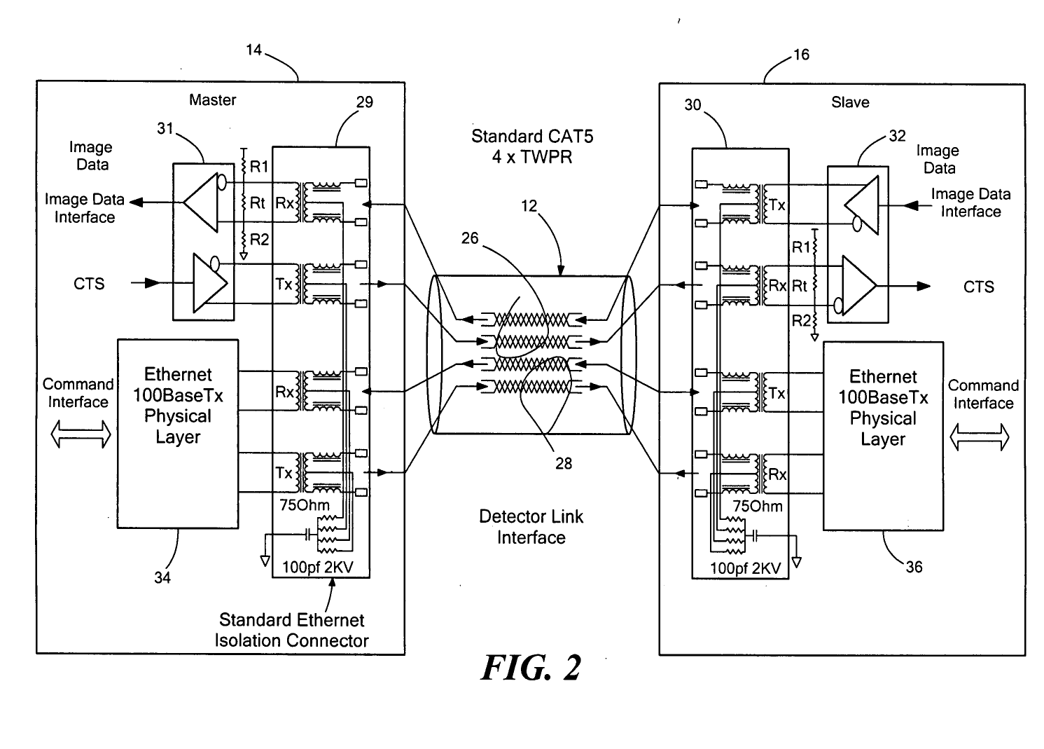

The Detector Link Interface 12 includes a CAT5 cable 24. Each one of the CAT5 cables includes two pairs of twisted pair (TWPR) 26, 28. One of the two pairs of twisted pairs (TWPR) 26, 28, here TWPR 28 carry image data and the other one of the pairs of twisted pairs, here TWPR 26 carry command data, as shown in FIG. 2. More particularly, the image data communication uses a full duplex Low Voltage Differential Signaling (LVDS) interface physical layers 31, 32 for the master detector 14 and slave detector 16, respectively, while the command communication uses standard Ethernet 100BaseTX interfaces 34, 36 for the master detector 14 and slave detector 16, respectively.

The LVDS interface 31, 32 is merged into the Ethernet interfaces 34, 36 by using the 2 un-used twisted pair (TWPR) of the standard Category 5 (CAT5) cable (standard media for the Ethernet 100BaseTx) thereby creating a hybrid coherent communication interface between 2 Gamma Detectors. The design merges a full duplex LVDS interface physical layers for image data communication into a standard Ethernet 100BaseTx interface, which is used for the command communication. The new hybrid interface 12 according to an embodiment of the present invention utilizes all industrial standard components and results in lower production cost and longer production life.

It is known to those skilled in the art that in the standard Ethernet 100BaseTx communication interface, only 2 twisted pair conductors of the standard CAT5 cable are used. This leave 2 unused twisted pair conductors for a full duplex LVDS communication interface. The Ethernet 100BaseTx also requires having isolation component at each node; therefore, in order for the LVDS to use the same hardware connector with the Ethernet, the LVDS also has to be able to interface via the same isolation component that the Ethernet used. As described above, an exemplary isolation connector used herein is the 10/100/1000BaseT standard connector 29 in order to utilize all 4 twisted pair conductors of the CAT5 cable. One LVDS channel is used as the Image data channel from Slave detector 16 to Master detector 14, here TWPR 26. The other channel is used as the Clear-To-Send (CTS) signal from Master detector 14 to Slave detector 16 for data flow control, here TWPR 28. An 8b/1Ob serial data encoding and decoding is performed on both Image and CTS serial data to create DC-balanced signals in order to be able to transfer via the Ethernet isolation connector.

The Ethernet interfaces is used as the Command interface between the 2 detectors. Even though the Ethernet data rate (100 Mbits/sec) is sufficiently high to be used for the Image data interface, however, due to software inconsistent time lags in handling the data, make it not well suitable for the time critical image data interface (Note: This is a special requirement for image data interface between Master and Slave detector but not as critical from the Master detector to Acquisition Computer). The advantage of the LVDS channel interface is that the protocol layer can be customized and implemented all in high-speed hardware thus having a very short and controllable time lag which is ideal for image data interface. Thus, it is to be noted that the LVDS interface 30, 32 has a physical layer characteristic very similar to the Ethernet physical layer 34, 36 and therefore standard or common interface media (cables and connectors) can be used.

Table 1 below lists some of the disadvantages of the prior art and the advantages of the present invention.

TABLE 1

| Advantages/Disadvantages | | |
|---|---|---|
| Comparison | This invention | Prior Art |
| Standard components usage | All components are widely used: | Many non standard components used: |
| | LVDS and Ethernet Physical layer ICs | TAXI Physical layer ICs |
| | Category 5 cable and connectors | Special Coaxial connector/cable for |
| | | TAXI. |
| Standard cost | Lower component and manufacturing | Higher component and manufacturing |
| | cost | cost |
| Obsolescent | Several suppliers. Longer component life | Limited supplier. Obsolete component. |
| Galvanic Isolation Interface | Galvanic Isolation interface is a standard, | Interface is not isolated, can be |
| | no extra component | achieved but at a significant amount of |
| | | extra cost. |
| System impact | Simplified cabling | Complex cabling |

Performance:

| | |
|---|---|
| Image Interface | Up to 66 Mbits/sec has been tested over 50 feet length of CAT5 cable. |
| | BER (Bit Error Rate) < 1 × 10⁻¹² |
| Command Interface | Standard Ethernet 100BaseTx |

A number of embodiments of the invention have been described. Nevertheless, it will be understood that various modifications may be made without departing from the spirit and scope of the invention. Accordingly, other embodiments are within the scope of the following claims.

What is claimed is:

1. An interface for coupling different types of data between a pair of devices, comprising:
a category 5 cable having two pairs of twisted pairs connected to the pair of devices;
wherein the pair of devices include:
a pair of differential signal interfaces, each one of such differential signal interfaces being connected to a different end of a first one of the pair of twisted pairs; and
a pair of Ethernet physical layers each one being connected to a different end of a second one of the pairs of the twisted pairs.

2. The interface recited in claim 1 wherein the pair of differential signal interfaces carries Low Voltage Differential Signals (LVDS).

3. A Single Photon Emission Computerize Tomography (SPECT) camera, comprising:
a master detector;
a slave detector;
an interface for coupling command data and image data between the master camera and the slave camera, comprising:
a category 5 cable having two pairs of twisted pairs connected between the master camera and the slave camera;
wherein the master camera and the slave camera have:
a pair of differential signal interfaces, each one of such differential signal interfaces being connected to a different end of a first one of the pair of twisted pairs for carrying the image data; and
a pair of Ethernet physical layers each one being connected to a different end of a second one of the pair of twisted pairs for carrying the command data.

4. A method for coupling different types of data between a pair of devices, one type of data requiring a higher data rate than the other type of data, comprising:
passing the higher rate data through a first pair of a pair of twisted pairs of a category 5 cable and passing the other through a second pair of the pair of twisted pairs of a category 5 cable.

5. The method recited in claim 4 including terminating the first pair of the pair of twisted pairs in differential signal interfaces and terminating the second pair of the pair of twisted pairs in Ethernet physical layers.

6. The method recited in claim 5 wherein one of the pair of devices is a master camera of a SPECT camera and the other device is a slave camera in the SPECT camera and wherein the higher data rate type data is image data and the other type of data is command data.

7. A method for coupling Low Voltage Differential Signals (LVDS) and Ethernet physical layer signals through a common transmission medium.

8. The method recited in claim 7 wherein the common transmission medium is a cable.

9. The method recited in claim 8 wherein the cable is a category 5 cable.

10. The method recited in claim 7 wherein the LVDS is transmitted on a first twisted pair and the Ethernet signals are transmitted on a second twisted pair.

11. The method recited in claim 7 wherein the transmission medium is connected between a first interface and a second interface.

12. The method recited in claim 7 wherein the transmission medium is connected between a first camera and a second camera.

13. The method recited in claim 12 wherein the first camera is a master camera and the second camera is a slave camera.

14. The method recited in claim 12 wherein the first camera and the second camera are gamma cameras.

15. The method recited in claim 12 wherein the LVDS and Ethernet signals are used to communicate command data and image data.
